(19) United States
(12) Patent Application Publication
(10) Pub. No.: US 2005/0270549 A1
(43) Pub. Date: Dec. 8, 2005

(54) Printing method for saving toners

(76) Inventors: Xing-Phing Zhou, Beijing (CN); Qiang Gu, Beijing (CN)

Correspondence Address: HARNESS, DICKEY & PIERCE, P.L.C., P.O. BOX 8910, RESTON, VA, 20195, US

(21) Appl. No.: 10/861,283

(22) Filed: Jun. 4, 2004

(51) Int. Cl. G06F 15/00

(52) U.S. Cl. 358/1.13

(57) ABSTRACT

A process of printing with saving toners creates a plurality of display list to be printed and records all attributes of pixels for each display list. Then, the attributes of pixels are retrieved. The mode of saving toner to be saved is adjusted according to the attributes of pixels. The matter is printed out thereafter. The attribute for each pixel can exactly differentiate from one another. Different pixel can be printed with proper amount of toners, so that the toners are economically used.

### BACKGROUND OF THE INVENTION

1. Field of Invention

The present invention relates to a printing method, in particular, to a printing method for saving toners.

2. Related Art

Printers have been widely used as output equipment. It is important for monochrome printers or color printers to reduce the consumption of toners with good printing quality. The matters to be printed include images, figures and texts. For printing texts or figures, exact outline and shapes of texts or figures are essential. For printing images, not only the exact outline and shape but also the contents of the images are essential.

Prior printing methods for saving toners process the whole raster image. Some of them change data signal voltage, tune the brightness of Gamma pixels for continuous pixels or mask half-tone images in matrix to reach the goal of reducing the toners consumption. Those proposed approaches light raster images that may consist of images, figures or texts in color at the same time. Prior methods are effective to images, but the boundaries and solid portions of texts and figures cannot be individually treated. For the printing results of texts or figures, only the outlines and the shapes are actually required. Generally, users mostly care about margins of the shape, so the area inside the shape can be lighter or even hollow.

There have been proposed Some printing processes have been proposed, that detect boundaries of raster images. Those processes can improve the brims of texts and figures, such as hollow texts. However, the processing of continuous-tone image is poor. For example, the color of continuous-tone images is distorted. This is caused by non-uniformly color tuning.

### SUMMARY OF THE INVENTION

The invention provides a printing method for saving toners, by which images, figures and texts can be printed out with a proper mold of saving toners. Not only the brims of the figures and the texts can be outlined, but also can the images contain a higher quality.

In order to achieve the above and other objectives, the method of the invention performs printing according to the attributes of pixels. First, a plurality of display list to be printed is created and all attributes of pixels for each display list are recorded. The attributes of pixels are retrieved. The mode of saving toner is adjusted according to the pixel-attributes. The matter is printed out thereafter.

In the invention, the attributes for each pixel can exactly differentiate from one another. Different pixels can be printed with a proper mode of saving toners, so that the toners are economically used.

### BRIEF DESCRIPTION OF THE DRAWINGS

FIG. 1 is an overall flowchart of a printing method for saving toners according to the invention;

FIG. 2 is a flowchart of a printing method for saving toners according to the first embodiment of the invention;

FIG. 3 is a flowchart illustrating the retrieving of boundaries of texts and figures;

FIG. 4a to FIG. 4c illustrate layouts not subjected to toner treatment in the art; and

FIG. 5a to FIG. 5c illustrate layouts subjected to toner treatment according to one embodiment of the invention.

### DETAILED DESCRIPTION OF THE INVENTION

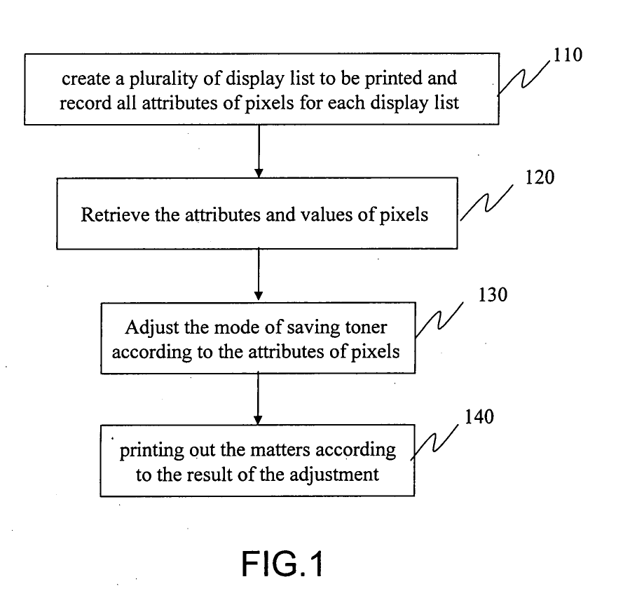

The printing method for saving toners exactly differentiates attributes of pixels and prints the pixels respectively with required mold of saving toners. FIG. 1 is a flowchart of a printing process for saving toners. As illustrated, create a plurality of display list to be printed and record all attributes and all values of pixels for each display list (step 110). The attributes include images, figures and texts. Retrieve the attributes of pixels (step 120). Adjust the mode of saving toner according to the attributes of pixels (step 130). Print out the matter after step 130 (step 140).

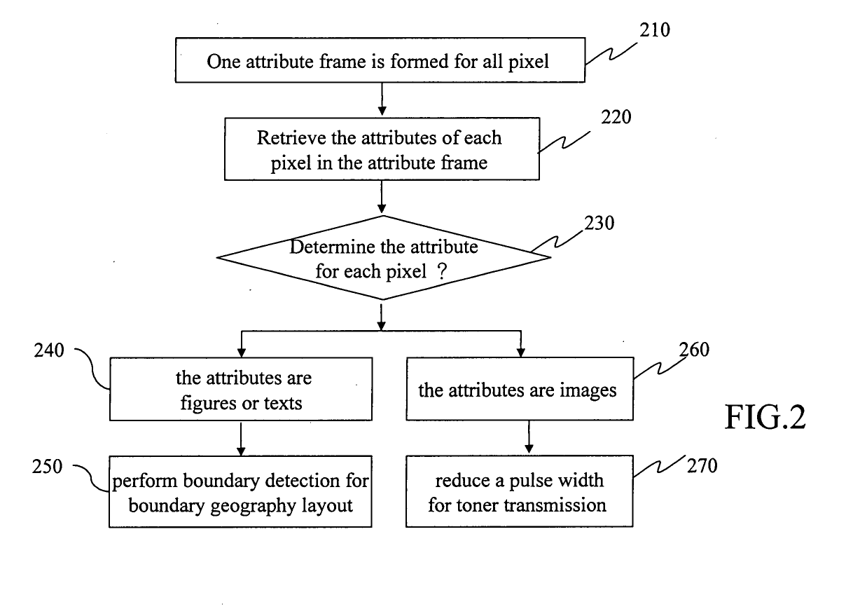

FIG. 2 is a flowchart of printing method for saving toners according to one embodiment of the invention. Raster images are saved in frame buffer. The raster images include color images and gray images, each image formed by pixels. Each pixel can be indicated in a unit of 1, 2, 4, or 8 bits. The color image is constructed of 4 CMYK frames, while the gray frame is constructed of one frame. Raster images, texts or figures that may override each other may form the raster image. It is hard to differentiate if image, figure or text forms the finally formed pixel. Therefore, there is a need of addresses to record attributes of each pixel so that the attributes of each pixel can be correctly recognized.

Only one attribute frame are formed for all the raster image frames (step 210). The attributes of each pixel are recorded in the frame. If the pixel attributes are figures or texts, then the corresponding frame is designated as 1. If the attributes of each pixel are images and others, then the frame is designated as 0. Thereby, the texts, figures and images can be respectively processed. In case the images, figures and texts are constructed by pixel groups in units of two pixels, a first reference numeral 00 indicates others, a second reference numeral 01 indicates texts, a third reference numeral 10 indicates figures, and a fourth reference numeral 11 indicates images. This realizes printing with a reduced amount of toners. Check the attributes of each pixel in the attribute frame (step 220). Determine the attribute for each pixel (step 230). If the attributes are figures or texts (step 240), then perform boundary detection for boundary geography layout (step 250). In the boundary detection, upper, lower, left and right pixels of one target pixel are checked to determine if they have the same attributes. If the upper, lower, left and right pixels have the same attributes and the attributes are figures or texts, then the target pixel is regarded as a central point, which can be omitted or lighted in color. If not, then the target pixel is regarded as one part of the boundary of the figure or text. At the moment, the boundary can be normally printed. If the attributes are images (step 260), one corresponding PWPM signal can be retrieved from a Lookup Table by searching the gray value of the target pixel to reduce a pulse width for toner transmission (step 270). Thereby, the toners absorbed on papers are reduced and thus the picture formed by the pixels is lighted in color.

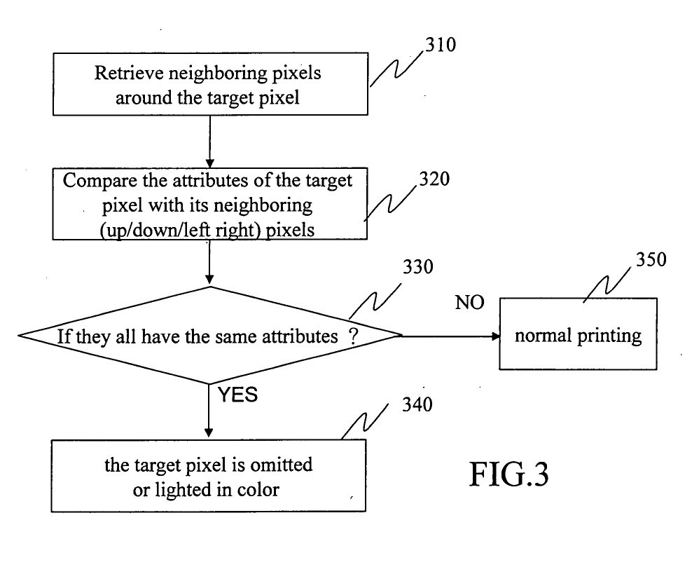

FIG. 3 is a flowchart illustrating the retrieving of boundaries of texts and figures. Retrieve neighboring pixels around the target pixel (step 310). The neighboring pixels can be left, right, upper and lower pixels around the target pixel or those surrounding the target pixel. Compare the attributes of the target pixel with its neighboring pixels (including up, down, left, and right) (step 320). If they all have the same attributes (step 330), the target pixel is an inner point of the figure or text, and thus the target pixel is omitted or lighted in color (step 340). If the target pixel has the attributes different from those of its neighboring pixels, then perform normal printing (step 350).

In color laser printing, all frame needs one attribute frame cache. If the pixel is designated as 1, it means the pixel has one figure or text attribute. If the pixel is designated as 0, it means the pixel has an image or other attribute. Even though the CMYK addresses are already provided for all the frames, only one attribute frame cache is needed for recording the attribute data each time. Check the attribute for each pixel on the attribute frame cache. If they are figures or texts, then the attribute frame cache is designated as 1. If they are images or other, then the attribute frame cache is designated as 0. In printing, each pixel attribute in the attribute frame cache is first checked. If they are figures or texts, then perform boundary detecting to achieve printing of hollow characters. If they are images, then a pulse width for toner transmission is reduced to reduce the absorption of toners, thereby uniformly lighting up the colors of the picture.

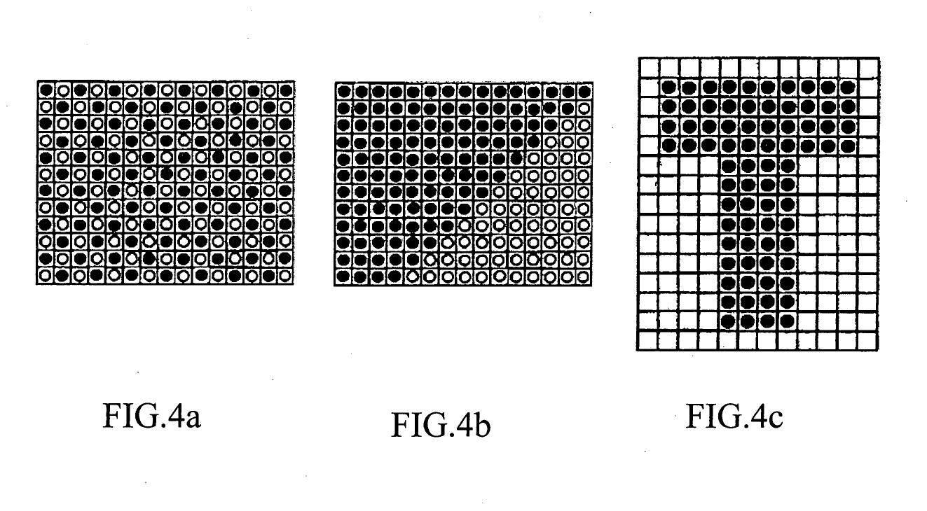

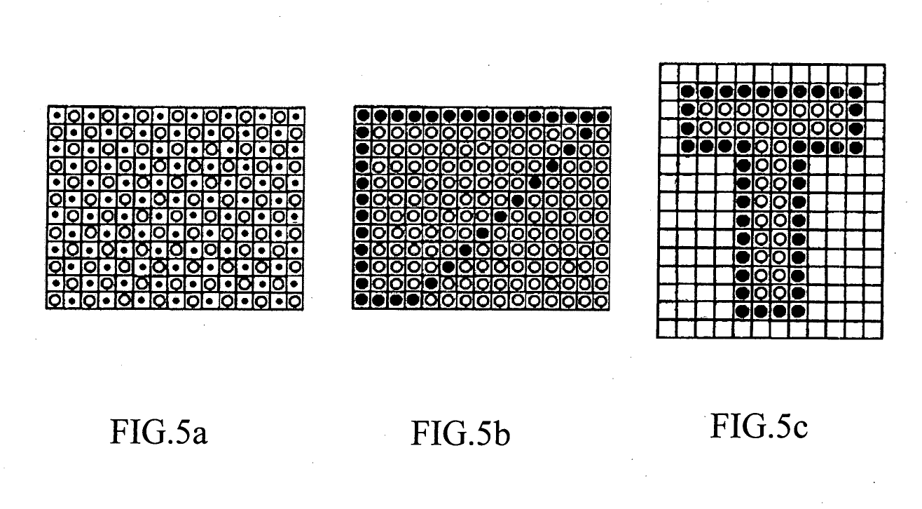

FIG. 4a to FIG. 4c illustrate layouts not subjected to toner treatment in the art. FIG. 5c illustrate layouts subjected to toner treatment according to one embodiment of the invention. Pixel attributes in FIG. 4a are images. Those pixels are lighted in strength after being subjected to the toner reduction, as shown in FIG. 5a. Pixel attributes in FIG. 4b and FIG. 4c are respectively figures and texts. Those figures and text are outlined after being subjected to the toner treatment, as respectively shown in FIG. 5b and FIG. 5c.

1. A printing method for saving toners, which prints matters according to attributes of pixel, the method comprising:
creating a plurality of display list to be printed and recording all attributes of pixels for each display list;
retrieving the attributes of pixels;
adjusting the mode of saving toner according to the attributes of pixels; and
printing out the matters according to the result of the adjustment.

2. The method of claim 1, wherein the attributes include images, figures and texts.

3. The method of claim 1, wherein the step of a adjusting the mode of saving toner according to the attributes of pixels further includes:
if the pixel attribute is an image, then reduce a pulse width for toner transmission;
if the pixel attribute is a figure, then retrieve the outline of the figure; and
if the pixel attribute is a text, then retrieve the outline of the text.

4. The method of claim 1, further comprising a color-balancing step when the pixel attribute is an image.

5. The method of claim 1, wherein the step of retrieving the outline of the figure further comprising:
retrieving neighboring pixels around a target pixel;
comparing the attributes among these pixels; and
lighting the pixels in color according to the comparison result.

6. The method of claim 1, further comprising the step of caching the attributes of pixels.
